(19) United States
(12) Patent Application Publication
(10) Pub. No.: US 2018/0108447 A1
(43) Pub. Date: Apr. 19, 2018

(54) Compact X-Ray Images

(71) Applicant: TURNER INNOVATIONS, LLC., Orem, UT (US)

(72) Inventors: D. Clark Turner, Payson, UT (US); Thomas L. Youd, Salt Lake City, UT (US)

(21) Appl. No.: 15/568,708

(22) PCT Filed: Apr. 22, 2016
(86) PCT No.: PCT/US16/29022

§ 371 Date: Oct. 23, 2017

Related U.S. Application Data
(60) Provisional application No. 62/151,764, filed on Apr. 23, 2015.

(51) Int. Cl. G21K 5/10; G21K 4/00

(52) U.S. Cl. CPC G21K 5/10; G21K 2004/12; G21K 4/00

(57) ABSTRACT

Small, portable, and collapsible X-ray devices are described in this application. In particular, this application describes a portable X-ray device that contains a C-shaped support arm, an X-ray source contained near one end of the support arm, and an X-ray detector contained near the other end of the support arm, and the X-ray source is enclosed in a housing that also encloses a power source and a power supply. The X-ray device is portable since it can be configured to be carried by hand from location to location without using wheels or a gantry. The C-shaped support arm capable of rotating around an object to be analyzed that remains in a substantially fixed location when removably attached to a support structure using a connection that also allows the connection point to slide along the arc of the C-shaped support arm. The x-ray device can be quickly de-coupled from the support structure for handheld or table-top use. The C-shaped support arm can be configured to change the location of the X-ray source and X-ray detector relative to each other by being collapsible, reducing the volume of the x-ray device making it easier to transport. Other embodiments are described.

### FIELD

This application relates generally to X-ray equipment. More specifically, this application relates to X-ray equipment that is small, portable, and collapsible.

### BACKGROUND

X-ray imaging systems typically contain X-ray source and an X-ray detector. X-rays (or other type of radiation) is emitted from the source and impinges on the X-ray detector to provide an X-ray image of the object or objects that are placed between the X-ray source and the detector. The X-ray detector is often an image intensifier or even a flat panel digital detector. In some configurations, these devices contain a C-arm assembly with the source and detector on opposite ends of the “C” arm of the assembly. The C-arm assembly can move through continuous rotation angles relative to the object in order to acquire images from multiple orientations.

Some X-ray imaging systems have limited mobility since they contain a gantry that is secured to a floor, wall, or ceiling. Other imaging systems are more portable since they contain a mobile base (on wheels) and so they can be used in a variety of clinical environments, such as radiology and surgery departments of a medical facility.

### SUMMARY

This application relates generally to small, portable and collapsible X-ray devices. In particular, this application describes a portable X-ray device that contains a C-shaped support arm, an X-ray source contained near one end of the support arm, and an X-ray detector contained near the other end of the support arm, and the X-ray source is enclosed in a housing that also encloses a power source and a power supply. The X-ray device is portable since it can be configured to be carried by hand from location to location without using wheels or a gantry. The C-shaped support arm capable of rotating around an object to be analyzed that remains in a substantially fixed location when removably attached to a support structure using a connection that also allows the connection point to slide along the arc of the C-shaped support arm. The x-ray device can be quickly de-coupled from the support structure for handheld or table-top use. The C-shaped support arm can be configured to change the location of the X-ray source and X-ray detector relative to each other by being collapsible, reducing the volume of the x-ray device making it easier to transport.

### BRIEF DESCRIPTION OF THE DRAWINGS

The following description can be better understood in light of the Figures which show various embodiments and configurations of the X-ray devices.

FIG. 1 shows a view of some embodiments of small, portable and collapsible X-ray devices;

FIG. 2 shows another view of some embodiments of small, portable and collapsible X-ray devices;

FIG. 3 shows yet another view of some embodiments of small, portable and collapsible X-ray devices;

FIG. 4 illustrates a close-up of some embodiments of small, portable and collapsible X-ray devices;

FIGS. 5A, B, and C shows a view of some methods of using small, portable and collapsible X-ray devices in field use;

FIGS. 6A and 6B show some methods of using small, portable and collapsible X-ray devices in an operating room;

FIG. 7 shows other methods of using small, portable and collapsible X-ray devices;

FIG. 8 shows some embodiments of small, portable and collapsible X-ray devices being connected to a support structure;

FIG. 9 shows some embodiments of small, portable and collapsible X-ray devices being connected to a wheeled support structure;

FIG. 10 shows some embodiments of small, portable and collapsible X-ray devices in various collapsed configurations;

FIG. 11 shows additional embodiments of small, portable and collapsible X-ray devices with triggers on the cross members of the frame; and

FIGS. 12A, B, C show yet other embodiments of the small, portable and collapsible X-ray devices.

Together with the following description, the Figures demonstrate and explain the principles of the structures, methods, and principles described herein. In the drawings, the thickness and size of components may be exaggerated or otherwise modified for clarity. The same reference numerals in different drawings represent the same element, and thus their descriptions will not be repeated. Furthermore, well-known structures, materials, or operations are not shown or described in detail to avoid obscuring aspects of the described devices.

### DETAILED DESCRIPTION

The following description supplies specific details in order to provide a thorough understanding. Nevertheless, the skilled artisan will understand that the described X-ray devices can be implemented and used without employing these specific details. Indeed, the described systems and methods for controlling X-ray devices can be placed into practice by modifying the described systems and methods and can be used in conjunction with any other apparatus and techniques conventionally used in the industry. For example, while the description below focuses on C-arm x-ray devices, other X-ray imaging arms and x-ray devices can be used, including U-arms or portable x-ray devices with separate detectors that are configured to approximate the C-arm configuration.

In addition, as the terms on, disposed on, attached to, connected to, or coupled to, etc. are used herein, one object (e.g., a material, element, structure, member, etc.) can be on, disposed on, attached to, connected to, or coupled to another object—regardless of whether the one object is directly on, attached, connected, or coupled to the other object or whether there are one or more intervening objects between the one object and the other object. Also, directions (e.g., on top of, below, above, top, bottom, side, up, down, under, over, upper, lower, lateral, orbital, horizontal, etc.), if provided, are relative and provided solely by way of example and for ease of illustration and discussion and not by way of limitation. Where reference is made to a list of elements (e.g., elements a, b, c), such reference is intended to include any one of the listed elements by itself, any combination of less than all of the listed elements, and/or a combination of all of the listed elements. Furthermore, as used herein, the terms a, an, and one may each be interchangeable with the terms at least one and one or more.

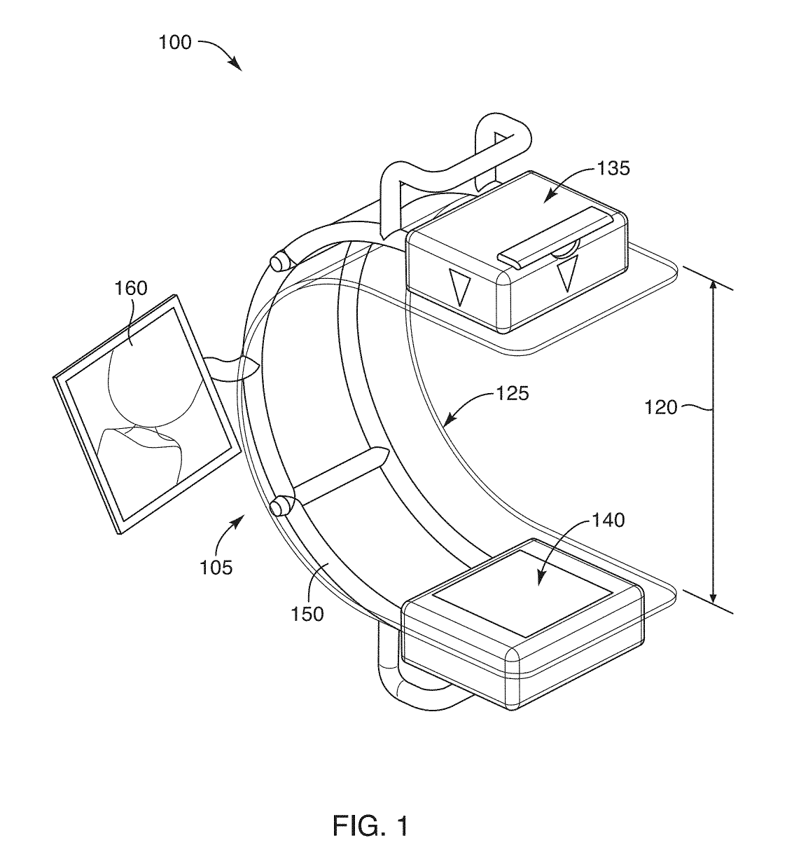

FIGS. 1-10 show some embodiments of the portable X-ray devices 100. The X-ray devices 100 contain an imaging arm that allows the system to be used to take X-ray images of a portion of a patient's body or any other object capable of being analyzed by x-rays, including animals, industrial components such as electronic circuit boards, containers to be inspected, and/or passenger luggage. In some configurations, the imaging arm is substantially shaped like the letter “C” and is therefore referred to as a C-shaped support arm (or C-arm) 105. The C-arm has any size that can be held and operated by hand when in use, as seen in FIG. 1.

The C-arm 105 can contain any X-ray source 135 and X-ray detector 140 that allow the X-ray system 100 to take X-ray images. The X-ray source 135 can contain any source that generates and emits X-rays, including a standard stationary anode X-ray source, microfocus x-ray source, rotating anode x-ray source, and/or a fluoroscopic X-ray source. In some embodiments, the x-ray source can operate with about 40 to about 90 kV and from about 1 to about 10 mA. In other embodiments, the x-ray source can operate with about 75 kV and about 2 mA. In some embodiments, the X-ray source and X-ray detector can be made modular so that different sizes and types of X-ray sources and X-ray detectors can be used.

And the X-ray detector 140 can contain any detector that detects X-rays, including an image intensifier, CMOS camera and/or a digital flat panel detector. In some configurations, the detector can have a substantially square shape with a length ranging from about 13 cm to about 15 cm. In other configurations, though, the x-ray detector 140 does not need to have a substantially square shape.

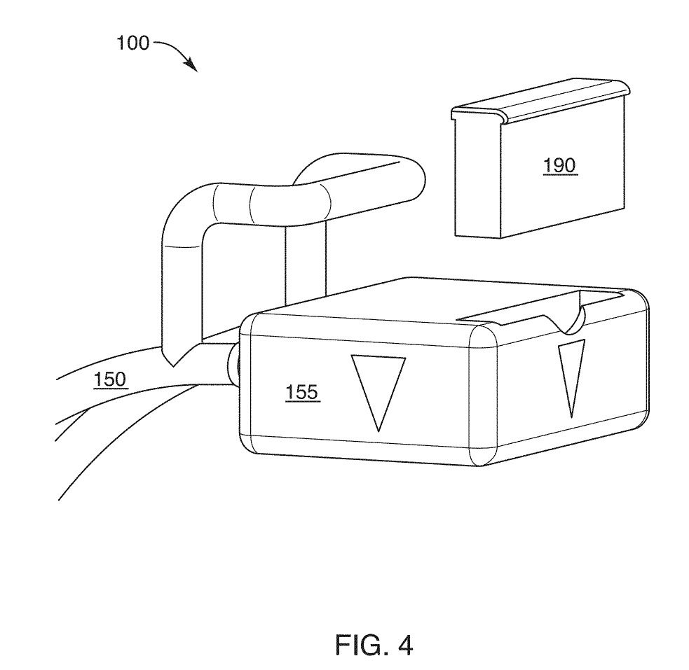

As shown in detail in FIG. 4, the X-ray source 135 can be contained in a housing 155. The housing 155 can be configured in two parts with a first part enclosing the x-ray source 135 as shown in FIG. 4 and a second, separate part enclosing the x-ray detector 140. In other configurations, however, the housing 155 can be configured so that it is a single part that encloses both the X-ray source 135 and the X-ray detector 140. Some of the housing 155, if desired, could be configured to enclose the C-arm 105.

In some configurations, the housing can also enclose a removable power source 190 (such as a battery) and optionally a power supply. Thus, the power source 190 and the power supply can be located internal to housing 155 and also to the x-ray device 100. The supporting electronics for the power source 190 and the power supply, as well as the supporting electronics for the image display and for wireless data upload described herein, can also be located internal to the housing 155. Thus, in these configurations, the x-ray device 100 does not contain an external power cord. Incorporating the power source (i.e., the battery), the power supply, and the supporting electronics all within the housing 155 allows the size and the weight of the device to be reduced. With such a configuration, the power source can easily be replaced and delivers 60 or more x-ray images using a single charge. Of course, if needed, the x-ray device can be configured so that it is alternately, or additionally, charged using external power from a power cord that is plugged into a wall outlet. In other configurations, multiple power supplies can be provided for the source, detector, and control electronics, any (or all) of which can be located either internal or external to the housing 155.

In some configurations, the C-arm 105 can be configured to support the X-ray source 135 and the X-ray detector 140 so that they are respectively disposed at nearly opposite ends of the imaging arm and substantially face each other as shown in FIGS. 1-3. In these configurations, a distance 120 exists between the x-ray source and the x-way detector for an object to be placed between them and analyzed using the x-rays.

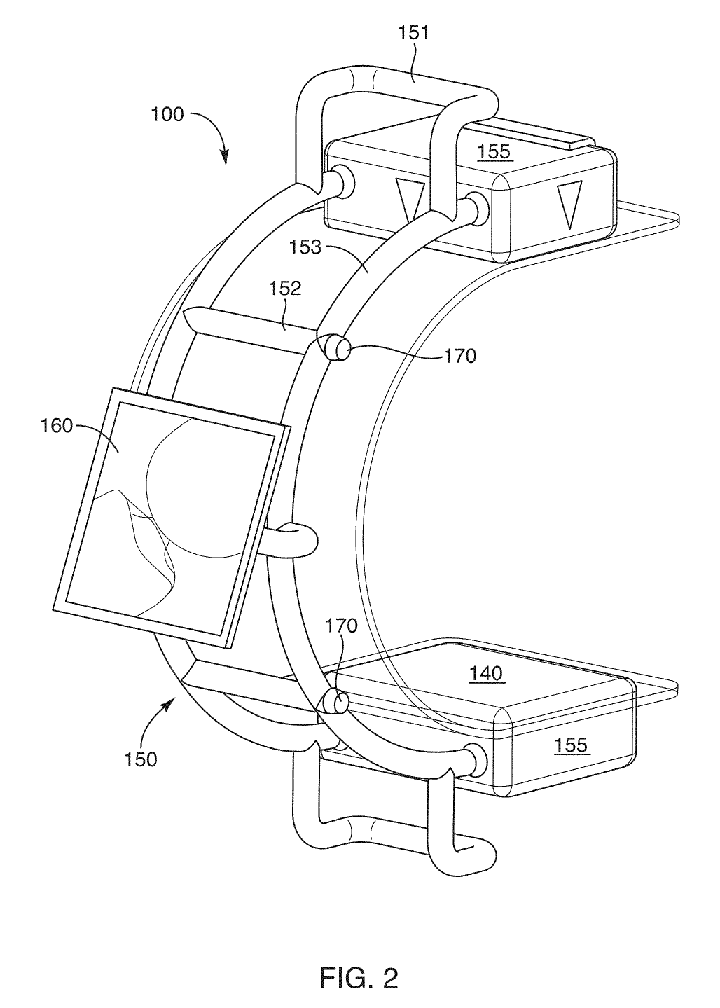

The X-ray device 100 also contains a frame 150 that has an open configuration. As shown in FIG. 2, an open configuration gives a number of easy gripping options for a user to carry and hold the frame 150 during transport, and optionally during operation of the x-ray device 100. Other configurations of the frame 150 can be used for the device, including using more or fewer cross members 152, more or fewer length members 153, and/or different configurations for the handles 151. The length and diameter of the various members in the frame 150 can be changed as needed for a variety of operators. In some embodiments, the frame 150 can be configured as a modular unit so different cross members 152 (or length member 153 or handles 151) can be used to replace the existing cross members 152 (or length member 153 or handles 151). Thus, the frame 150 provides the ability for a user (or operator) to grip and hold the X-ray device 100 during operation, a feature that is useful since other conventional C-arms can't be held in the hands while being operated because they do not have a frame and because, as explained herein, they are too heavy.

The frame 150 can also contain buttons (or triggers) 170 that can be used to operate the X-ray device 100. In some configurations, the X-ray device can be configured with two or more triggers 170 as shown in FIG. 2. In these configurations, the triggers can be provided in multiple locations on the frame 150 so that regardless of how the x-ray device 100 is held in the hands of an operator, a trigger is always convenient for the operator to use. For example, the triggers 170 can be placed at the locations on the X-ray device 100 illustrate in FIG. 2 where the cross member 152 and the length member 153 intersect. In another example, the triggers can be placed on the handles 151. This allows the operator to press the trigger when the device is held by the operator in the position where the detector is on the left side or when the device is held by the operator in a different positions where the detector is on the right side, or held vertically with the detector at the top or detector at the bottom. These multiple triggers make it easier to operate and easier to hold in the hand of the user when it is be used for analysis of an object. For the triggers to operate the device, the needed internal electronics can be carried inside the frame 150. In other configurations, one or more of these triggers can be a remote trigger. Optional button shrouds and/or compulsory push sequences can be used to prevent accidental x-ray emissions.

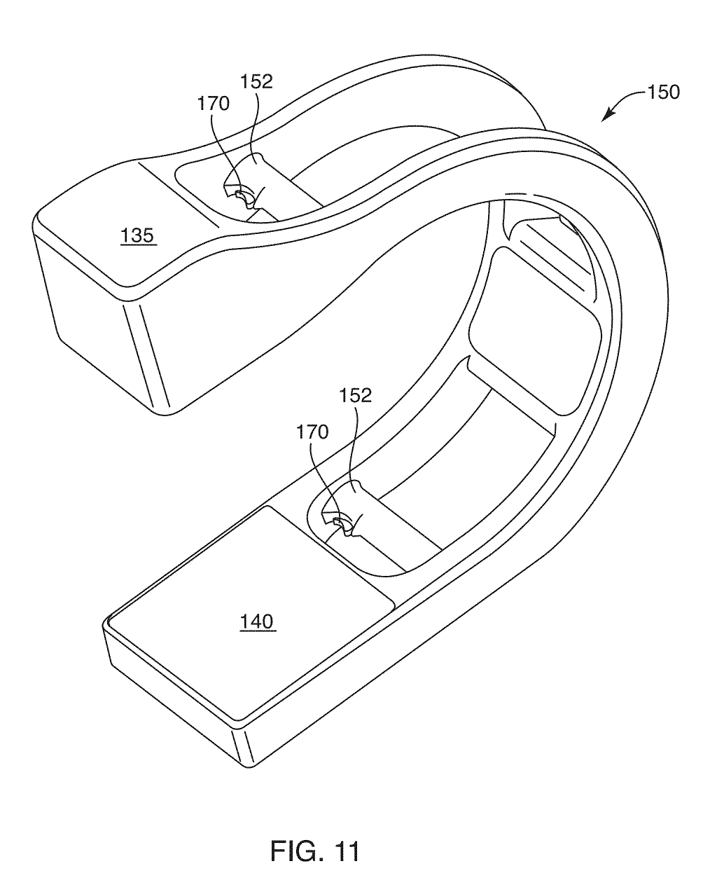

Other configurations of the frame 150 and the triggers are illustrated in FIG. 11. In these configurations, the triggers 170 are located on the cross members 152 that are located near the end of the arc of the C-shaped support arm. Thus, the cross-members 152 in these embodiments can be used as handles, allowing the handles 151 shown in FIG. 2 to be eliminated. Such configurations make it extremely easy and comfortable for the user to hold the X-ray device 100 using these cross-members and actuate the triggers 170.

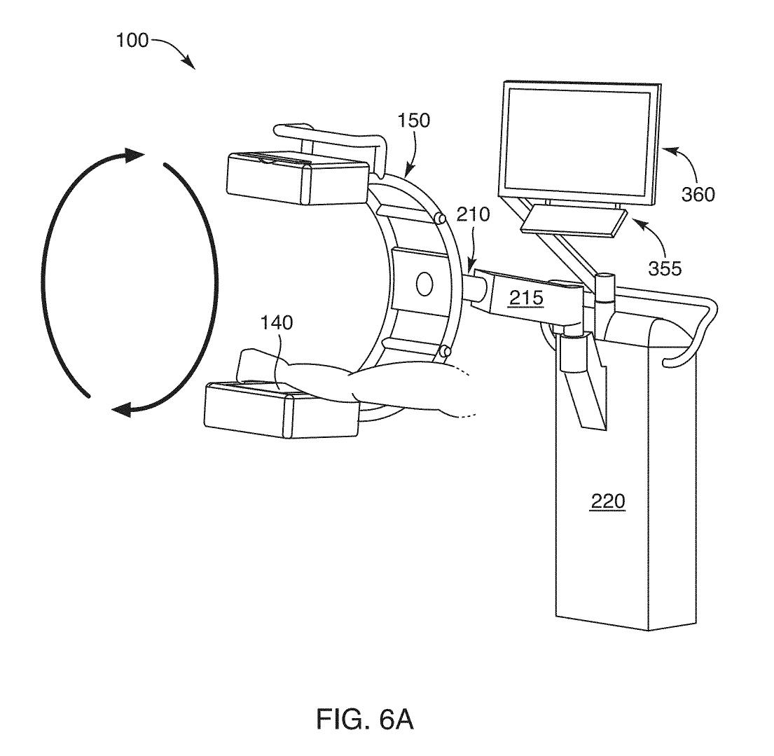

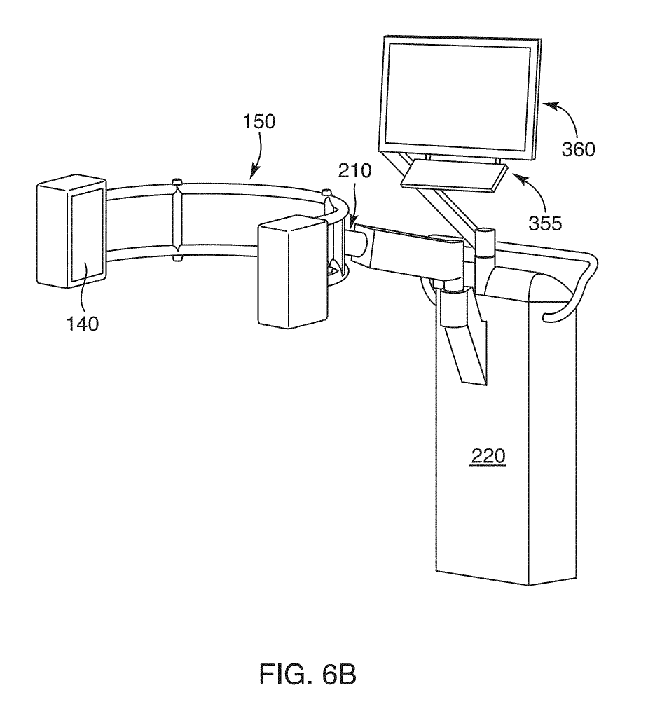

In some embodiments, the frame 150 can be connected to an external (or support) structure so that it can rotate around an object being analyzed, as shown in FIG. 6. In these embodiments, the connection between the frame 150 and the external structure contains triple function joint (or tri-joint) 210 that allows the following three functions. First, the tri-joint 210 can be attached to the C-arm 105 and the support structure so that the C-arm 150, similar to other conventional C-arms, can rotate around the object (i.e., from the position in FIG. 6A to the position in 6B) being analyzed (i.e., the arm of a patient). Second, the tri-joint 210 allows the X-ray device to be quickly and easily attached (and detached) from the external structure. And third, the tri-joint 210 allows the connection between the X-ray device 100 and the external structure to be located at any desired location of the frame (i.e., at 15, 30, 45, 60, 75, 90, 105, 120, 135, 150, and 165 degrees along the arc of the C-arm, or at any located therebetween). For example, as shown in FIG. 6A the tri-joint 210 is connected to x-ray device 100 at about 90 degrees along the arc of the C-arm while in FIG. 6B the tri-joint 210 is connected to x-ray device 100 at about 60 degrees.

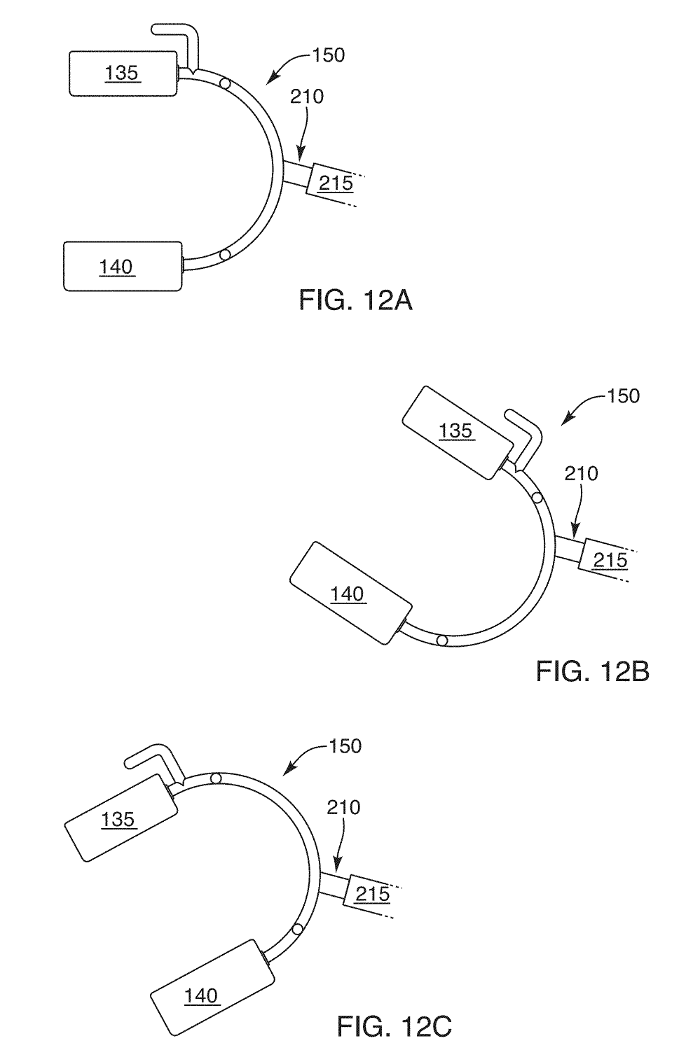

Another example of this third functionality is illustrated in FIGS. 12A, B, and C. As shown in FIG. 12A, the x-ray device 100 can be connected to the extension 215 of an external support structure using a tri-joint 210. The x-ray device 100 can be connected at a first position along the arc of the device. FIG. 12B shows that the connection point can be changed by sliding along the arc until a different, second position is obtained. And FIG. 12C shows that the connection point can be changed again by sliding along the arc in a different direction until yet a different, third position is obtained.

FIGS. 6A and 6B shows some embodiments in which the tri-joint 210 is attached at one end to the frame 150 of X-ray device 100 and at the other end to an extension 215 that extends from the external structure. In the embodiments shown in FIGS. 6A and 6B, the external structure comprises a supporting base 220 to which the extension 215 is connected. The support structure can also contain any other medical components and electronic components, as described herein like the display 360 and the user interface 355. In some configurations, the X-ray device 100 can be covered with a surgical drape for surgical procedures.

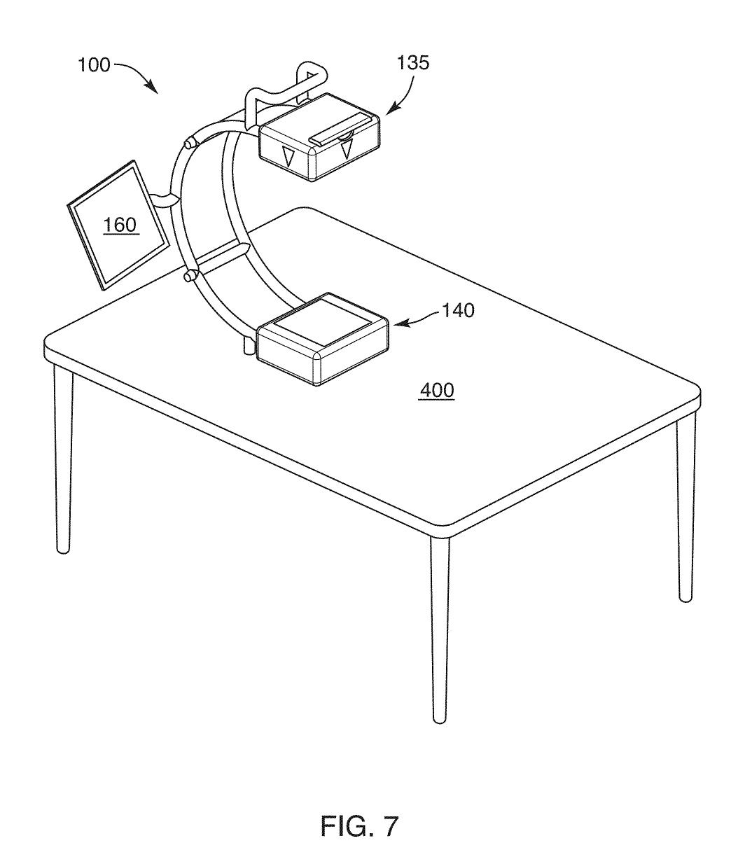

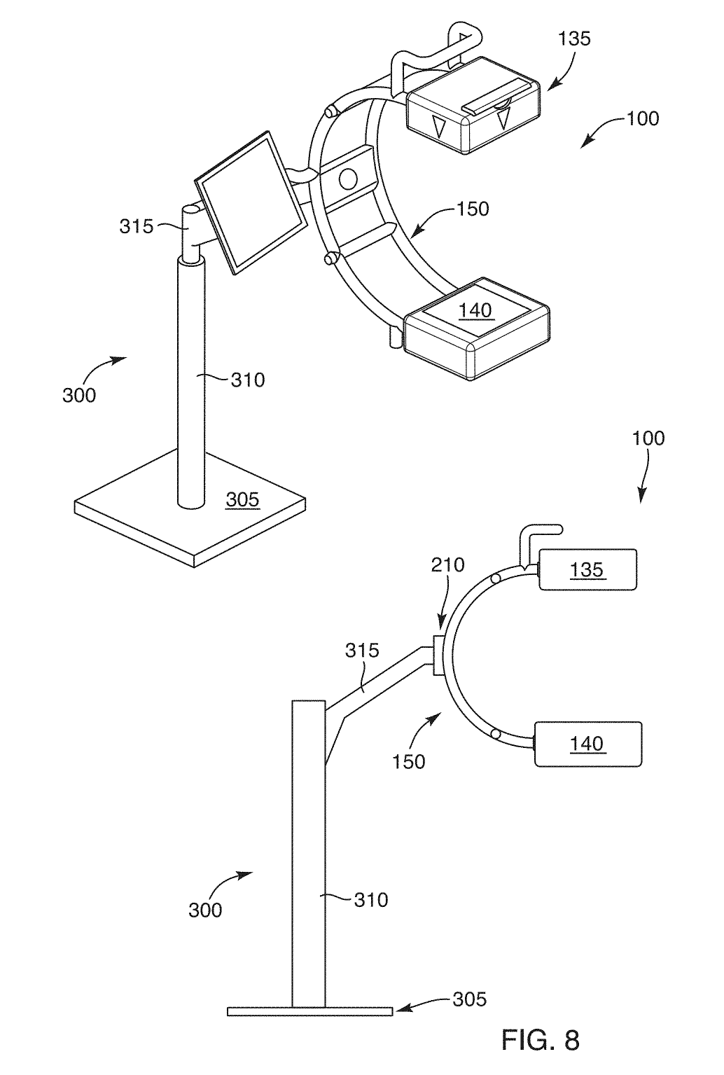

Another example of an external structure is illustrated in FIG. 8. In this FIG. 8, the x-ray device 100 can be connected to a stand 300. The stand 300 contains a base 305 and an arm 315 extending upwards towards an extension 310. The extension 310 is connected to the pivot joint 210 which is, in turn, is connected to the frame 150 of the x-ray device 100. In other configurations, the 300 could be oriented so that the base 305 is fixed to a wall and arm 315 extends in a general horizontal direction. Of course, the stand 300 could be fixed or removably attached to any number of surfaces. And as shown in FIG. 7, the x-ray device can merely rest on any surface, such as the top of table 400.

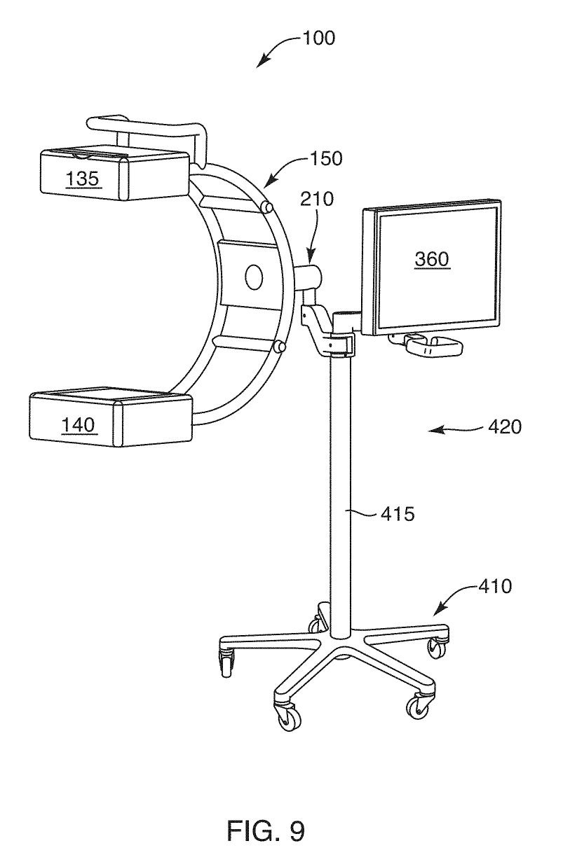

In other configurations, though, the x-ray device 100 can be connected to a movable support structure. In such configurations, the movable support structure can be configured to move across a floor while supporting the x-ray device 100. Thus, the movable support structure can comprise one or more wheels, shelves, handles, monitors, computers, stabilizing members, limbs, legs, struts, cables, and/or weights (to prevent the weight of the imaging arm and/or any other component from tipping the movable support structure). FIG. 9 shows some embodiments in which the movable support structure 420 comprises a wheeled structure 410 connected to a stand 415 that contains the tri-joint 210 that is connected to the x-ray device 100.

In some configurations, the X-ray device 100 and/or the external support structure can comprise any suitable locking mechanism that can selectively lock and unlock the rotation of the c-arm 105 around the object. For instance, the locking mechanism can comprise a manually-engaged clamp, a detent mechanism, a motorized lock, an electric lock, a radio controlled lock, a remotely engaged clamp, and/or any other suitable mechanism that can be used to lock and release the orbital rotation of the c-arm. In some configurations, the locking mechanism can be part of the tri-joint described herein or even an interface between the x-ray device 100 and the tri-joint.

The X-ray device 100 can also contain an optional shield 125. The shield 125 is used to protect a user from backscattered x-rays when the device 100 is operated. The shield 125 can accordingly be made any radiation shielding material (including a leaded acrylic material) and shaped so that it protects the user. The shield 125 can be configured to be removed from the x-way device 100, if needed.

The X-ray device 100 also contains a user input/output (I/O) mechanism. In some embodiments, the I/O mechanism contains a user interface and a display that is combined in a touchscreen monitor 160, as shown as shown in FIGS. 1-2. This monitor is connected to the frame 150 using a ball joint or any joint with multiple degrees of freedom so that the user or operator of the device can position the monitor 160 as desired. For example, the monitor can be positioned in a first orientation (as shown in FIG. 1), in a second orientation (as shown in FIG. 2), or any other desired position. In other configurations the x-ray device is merely connected to the I/O mechanism, as shown in FIG. 6.

The X-ray device 100 can be controlled by an operator, such as a clinician, a doctor, a radiologist, a technician, or other medically trained professionals and/or staff using the I/O mechanism. In some embodiments, the operator can control the X-ray device 100 at or from a central system control, such as a system control console adjacent the device. The operator can interface with the system control through a variety of optional user interfaces integrated with the I/O mechanism, as shown in FIGS. 1-2, or that remain separate from the I/O mechanism, as shown by the user interface 355 and display 360 in FIG. 6. The control console, the user interface, or both can be located adjacent the X-ray device 100, as shown in FIG. 6. In other embodiments, though, the control console and/or the user interface can be located remotely, such as in an adjacent room, so as to protect the operator from unnecessary exposure to X-rays.

In some configurations, the x-ray source 135 in the housing 155 can be shielded with a bismuth-filled (or other heavy metal) silicone material. Bismuth may be used in the radiation shielding instead of conventional lead because bismuth is considered one of the less toxic of the heavy metals, provides comparable radiation shielding to lead. As well, there exist a wide range of functional bismuth sources and methods for making them that provide increased flexibility in both design and manufacturing and allows for a greater range of function and use when compared with lead or lead-based materials. This shielding this is very effective at preventing leakage radiation, thereby protecting the operator from radiation exposure when using the x-ray device 100 in a handheld configuration.

The effectiveness of the radiation shielding in some embodiments is dependent on the atomic number, or Z-value, and density of the shielding material. A denser shielding material with a higher Z-value is a better shielding material for high energy x-rays and gamma rays. Thus, the radiation shielding can contain other high-Z metals, such as iodine (I), barium, tin, tantalum, cesium, antimony, gold, and tungsten.

The X-ray device 100 is very portable since it is configured to be carried by hand from location to location without using wheels or a gantry. Thus, the x-ray device 100 is much more portable relative to some conventional X-ray devices that contain these features. In some embodiments, the portability of the x-ray device is enhanced by reducing the weight of the entire device. Some x-ray devices that claim to be portable since they can be transported using wheels are still quite heavy since they can weigh anywhere from 100 to 200 pounds. Other x-ray devices that are portable, and can even be carried by hand in some configurations, can still weigh about 35 pounds. But configuring the x-ray devices as described herein allows the weight to be reduced to less than about 20 pounds. In other configurations, the weight of the x-ray devices as described herein can be reduced to less than about 17.5 pounds. In yet other configurations, the weight of the x-ray devices as described herein can be reduced to less than about 15 pounds.

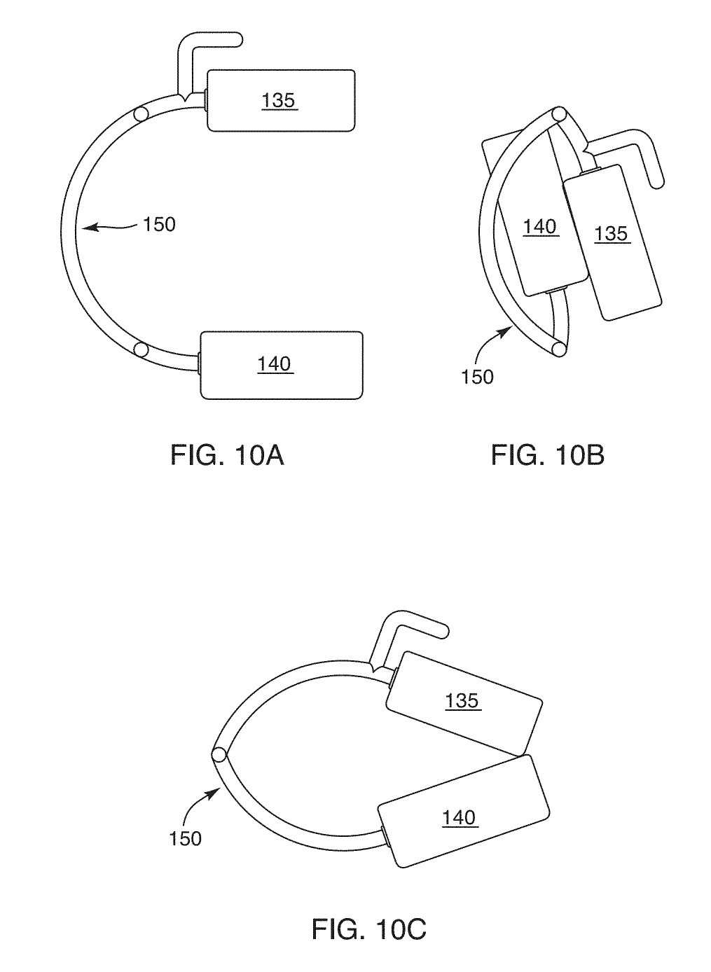

In some embodiments, the C-shaped support arm 105 can be configured to change the location of the X-ray source 135 and the X-ray detector 140. These embodiments allow the C-arm 105 of the x-ray device 100 to collapse on itself, making it even easier to carry and transport to a new location where the device is then restored to an expanded configuration and is then ready to be operated. The C-arm 105 can be made collapsible using any feature, including by containing hinges, containing a collapsible frame, telescoping, or by containing socketed pins. Examples of some of the configurations into which the x-ray device can be collapsed are illustrated in FIGS. 10A, B, and C. Of course, by using a different number (and location) of collapsing mechanisms, almost any number of collapsed configurations can be obtained.

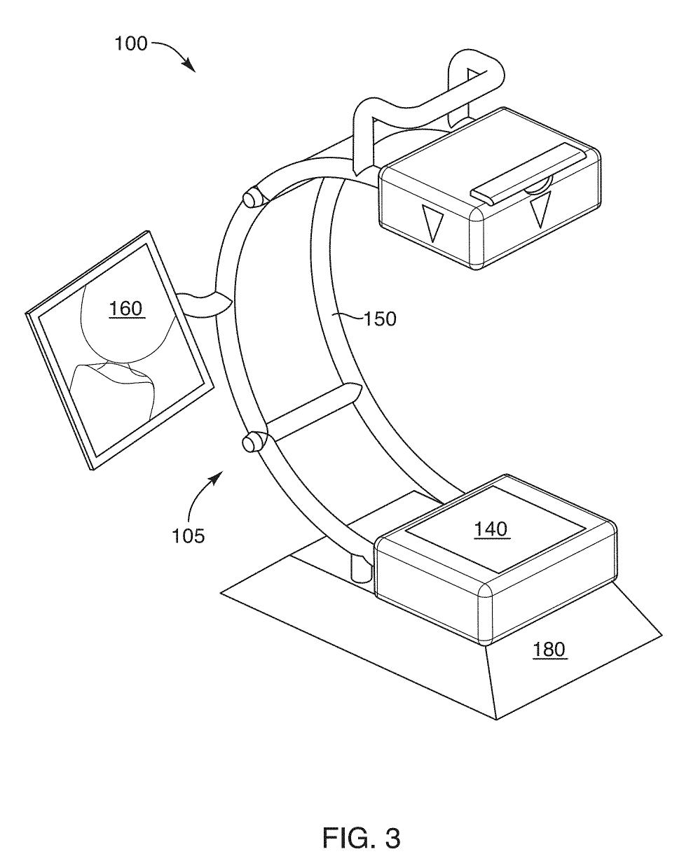

In some configurations, the X-ray device 100 can be placed on a cradle 180 as shown in FIG. 3. The cradle 180 helps provide a mechanical support in which the x-ray device can rest. Thus, the cradle 180 is configured with an upper surface that mates with the bottom surface of the x-ray device 100 to which it connects. The cradle can contain a quick mount and quick release mechanism. Indeed, such a mount and release mechanism can be used when removable attaching the x-ray device 100 to an external structure, including those described in FIGS. 6, 8, and 9.

The cradle 180 can also provide an electrical connection to the x-ray device 100. In these configurations, the cradle 180 contains a docking station. This allows the X-ray device 100 to be connected to a foot pedal 185 by a wired connection or a wireless connection which allows the user to control operation of the device with a foot.

The x-ray device 100 can also be connected to any type of electronic device with a wired or a wireless connection even without the cradle 180. In these embodiments, the x-ray device can contain communication cables that connect the detector to the desired electronic device, such as a computer, which can be used to analyze the x-ray images from the detector. In other embodiments, however, the detector 140 can be connected with any wireless communications device that can be paired with the desired electronic device.

The X-ray device 100 can be configured to be integrated with an optional surgical table into which the x-ray device 100 can slide into. The top of the x-ray detector 140 would be planar with the top of the optional surgical table, giving a larger platform to perform surgery right on the x-ray device 100 or after an optional protective covering is placed over the x-ray device. The table can have any depth that is the substantially the same thickness as the x-ray detector 140. A notch can be cut into the platform in which the C-arm slides into, positioning the detector at the center of the platform. The platform can have tapered sides to minimize the patient discomfort when using it.

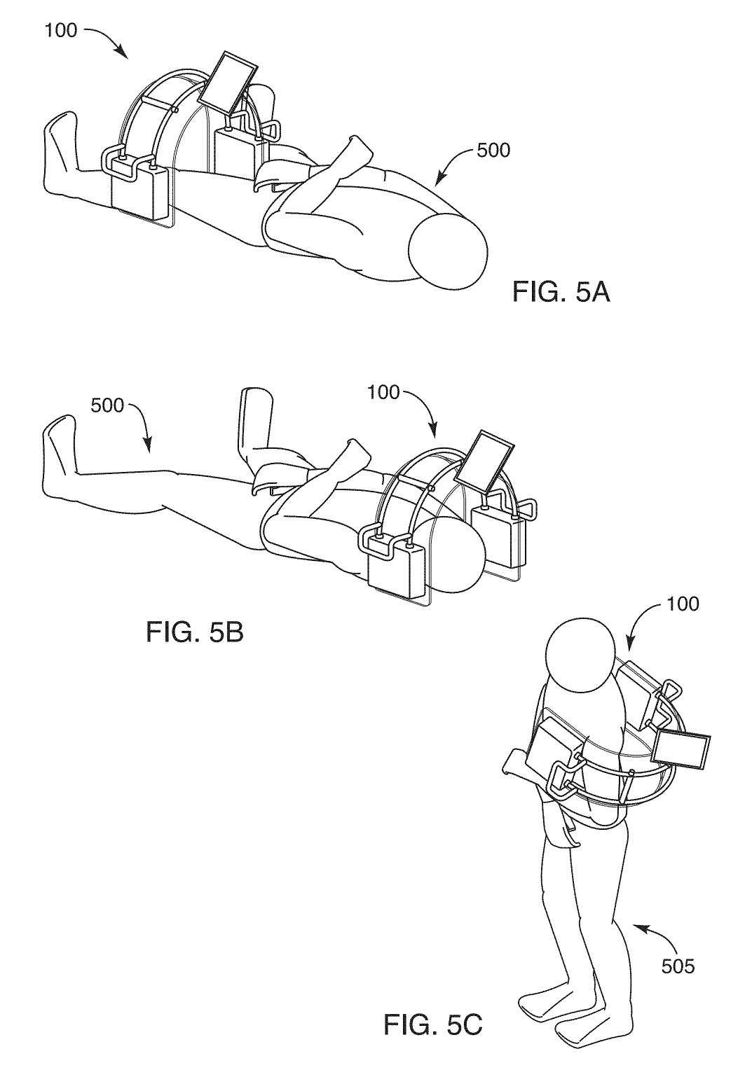

When in use, the x-ray device can physically be moved from one location to the next by hand as illustrated in FIG. 5A, B, and C. The ability to move the x-ray device 100 from one location of a patient 500 (i.e., the leg as shown in FIG. 5a) to another location (i.e., the head as shown in FIG. 5B), not to mention the ability to move the x-ray device 100 from one patient 500 (i.e., patient in FIG. 5A or 5B) to another patient 505 (i.e., patient shown in FIG. 5C), makes the x-ray device 100 extremely easy and convenient for use in the field where other x-ray devices can't be used.

When the x-ray device 100 is connected to an external structure, the C-shaped support arm 105 is capable of rotating around an object to be analyzed that remains in a fixed location. As illustrated in FIGS. 6A and B, an operator can rotate the C-arm 105 by grabbing any part of the frame 150 and rotating the arm clockwise and/or counter-clockwise while part of the patient remains substantially immobile in the middle of the C-arm 105. The operator can selectively lock the C-arm at any suitable location in its rotation and/or release the orbital rotation of the c-arm 105 by locking (or releasing) a locking mechanism.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. A portable X-ray device, comprising:
a C-shaped support arm;
an X-ray source contained near one end of the support arm;
an X-ray detector contained near the other end of the support arm;
wherein C-shaped support arm is configured to rotate the arm around an object to be analyzed by motion along the arc of the C-shape while being held by a support structure; and
wherein the C-shaped support arm is configured to be removed from the support structure and used in a stand-alone fashion for x-ray imaging.

2. The device of claim 1, wherein the X-ray device is configured to be carried by hand from location to location using a frame.

3. The device of claim 1, wherein the C-shaped support arm is configured to be removably attached to the support structure at different positions along the arc of the support arm.

4. The device of claim 2, further comprising multiple triggers located on a frame.

5. The device of claim 1, wherein the device weighs less than about 20 pounds.

6. The device of claim 2, wherein the X-ray device does not contain wheels or a gantry.

7. The device of claim 1, wherein the C-shaped support arm is configured to change the location of the X-ray source and X-ray detector relative to each other.

8. The device of claim 7, wherein the support arm is hinged.

9. The device of claim 7, wherein the support arm is collapsible.

10. A handheld X-ray device, comprising:
a collapsible C-shaped support arm;
an X-ray source contained near one end of the support arm;
an X-ray detector contained near the other end of the support arm;
wherein C-shaped support arm is configured to rotate the arm around an object to be analyzed by motion along the arc of the C-shape while being held by a support structure; and
wherein the C-shaped support arm is configured to be removed from the support structure and used in a stand-alone fashion for x-ray imaging.

11. The device of claim 10, wherein the X-ray device is configured to be carried by hand from location to location using a frame.

12. The device of claim 10, wherein the C-shaped support arm is configured to be removably attached to the support structure at different positions along the arc of the support arm.

13. The device of claim 11, further comprising multiple triggers located on a frame.

14. The device of claim 10, wherein the device weighs less than about 20 pounds.

15. The device of claim 11, wherein the X-ray device does not contain wheels or a gantry.

16. An x-ray system, comprising:
handheld X-ray device, comprising:
a collapsible C-shaped support arm;
an X-ray source contained near one end of the support arm;
an X-ray detector contained near the other end of the support arm;
wherein C-shaped support arm is configured to rotate the arm around an object to be analyzed by motion along the arc of the C-shape while being held by a support structure; and
wherein the C-shaped support arm is configured to be removed from the support structure and used in a stand-alone fashion for x-ray imaging.

17. The system of claim 10, wherein the X-ray device is configured to be carried by hand from location to location using a frame.

18. The system of claim 10, wherein the C-shaped support arm is configured to be removably attached to the support structure at different positions along the arc of the support arm.

19. The system of claim 11, further comprising multiple triggers located on a frame.

20. The system of claim 10, wherein the device weighs less than about 20 pounds.

21. The system of claim 11, wherein the X-ray device does not contain wheels or a gantry.
